(19) United States
(12) Patent Application Publication
(10) Pub. No.: US 2017/0308915 A1
(43) Pub. Date: Oct. 26, 2017

(54) SYSTEMS AND METHODS OF FORECASTING SEASONAL TRANSITIONS IN RETAIL SALES

(71) Applicant: Wal-Mart Stores, Inc., Bentonville, AR (US)

(72) Inventors: Nicholaus A. Jones, Fayetteville, AR (US); Aaron J. Vasgaard, Rogers, AR (US); Matthew A. Jones, Bentonville, AR (US); Todd D. Mattingly, Bentonville, AR (US)

(21) Appl. No.: 15/492,543

(22) Filed: Apr. 20, 2017

Related U.S. Application Data
(60) Provisional application No. 62/325,133, filed on Apr. 20, 2016.

(51) Int. Cl. G06Q 30/02; G06Q 10/08

(52) U.S. Cl. CPC G06Q 30/0202; G06Q 10/087

(57) ABSTRACT

In some embodiments, systems and methods are provided to forecast changes in seasons and/or changes in expected sales at one or more retail shopping facilities. In some embodiments, a system comprises a forecast control circuit; a memory storing computer instructions that cause the forecast control circuit to: forecast when a first changing of a first season to a second season is to occur at a first geographic area based on a detected change in sales of at least a first set of products at a first retail shopping facility located within the first geographic area; and forecast when in the future a second changing of the first season to the second season at a second geographic area is to occur based on a seasonal delay factor of the second geographic area relative to the occurrence of the changing of the first season at the first geographic area.

### CROSS-REFERENCE TO RELATED APPLICATION

This application claims the benefit of U.S. Provisional Application No. 62/325,133, filed Apr. 20, 2016, which is incorporated herein by reference in its entirety.

### TECHNICAL FIELD

This invention relates generally to retail inventory control and sales.

### BACKGROUND

In a modern retail environment, there is a need to improve the customer service and/or convenience for the customer. One aspect of customer service is having products on-hand at the retail shopping facilities. Lost sales can result when insufficient products are available.

### BRIEF DESCRIPTION OF THE DRAWINGS

Disclosed herein are embodiments of systems, apparatuses and methods pertaining forecasting demands of products as retail shopping facilities. This description includes drawings, wherein:

FIG. 1 illustrates a simplified block diagram of a system to forecast changes in retail sales of one or more products at one or more shopping facilities, in accordance with some embodiments.

FIG. 2 illustrates a simplified block diagram of an exemplary sales forecasting system, in accordance with some embodiments.

FIG. 3 illustrates a simplified flow diagram of an exemplary process of forecast seasonal transitions in retail sales, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein to forecast seasonal transitions in retail sales. Some embodiments forecast when in the future a changing of a season is to occur at a first geographic area based on a detected change in sales of at least a set of products at a retail shopping facility located within the first geographic area. The system further forecasts when in the future a changing of the season at a second geographic area is expected to occur based on a seasonal delay factor of the second geographic area relative to the occurrence of the changing of the season at the first geographic area.

Generally, changes of a season occur at different times based on geographic regions. For example, in North America, changes from spring to summer generally occur earlier in the year for geographic areas that are more southern than geographic areas that are more northern. As a specific example, changes in Florida from spring to summer generally occur earlier in the year than in Maine. As another example, with regard to North America, changes from fall to winter generally occur earlier in the year for geographic regions that are further north. Some embodiments estimate delays in changes of seasons between geographic regions. These estimated delays are used to forecast when in the future a change in a geographic area is expected to occur.

Changes in seasons typically correspond to changes in customers' purchase patterns at retailers. Further, the system can forecast when in the future a changing between two seasons are expected to occur based on changes in product purchasing rates and/or quantities. Accordingly, inventories at retail shopping facilities, distribution centers, fulfillment centers, and/or other such facilities can be adjusted in expectation of the change and/or consistent with the corresponding expected change in sales patterns.

The inventors have identified that forecasting of future sales can be difficult and many different factors can affect such future sales. It was further identified that such factors can include changes in seasons. Forecasting when seasons are to change can be difficult. Previous systems relied on historic data and current weather conditions. Other sales forecastings fail to take into consideration changes in seasons in other geographic areas as a factor in forecasting changes in season in a current geographic location. The inventors, however, identified that changes in sales in one or more geographic locations can be used to forecast changes in a season in a different geographic location and corresponding changes in sales based on the change in season. By utilizing unconventional rules applied unconventionally to sales data and a determination of an unconventional delay in a change of season relative to one or more other geographic locations, the present embodiments can provide improved future forecasting of sales relative to changes in a season at one or more particular shopping facilities within a geographic area. Previous sales forecasting failed consider such data, and failed to apply relevant rules to improve sales forecasting based on changes in seasons in other geographic location.

FIG. 1 illustrates a simplified block diagram of a system 100 to forecast changes in retail sales of one or more products at one or more shopping facilities, in accordance with some embodiments. The system includes one or more sales forecasting systems 102, and one or more inventory systems 104 for each of one or more retail shopping facilities, order fulfillment centers and/or distribution centers. The forecasting system 102 is in communication with the inventory systems 104 through one or more distributed computer and/or communication networks 106, such as WAN, LAN, Internet, and/or other such networks that provide wired and/or wireless communication. The system typically further includes one or more databases 108, which are part of and/or accessible to one or more of the sales forecasting system 102, the inventory systems 104, or other systems. Some embodiments further include one or more worker scheduling circuits or systems 112, which can be associated with one or more of the shopping facilities, fulfillment centers and/or distribution centers. Additionally, the system may include or the sales forecasting system 102 may be in communication with one or more weather services 114.

In some embodiments, the forecasting system 100 includes and/or is in communication with one or more so-called Internet of Things (IOT) 116 (such as smart phones, tablets, smart TVs, computers, laptops, and so forth). In some instances, the Internet of Things may include network edge elements (i.e., network elements deployed at the edge of a network). In some case a network edge element is configured to be personally carried by a person. Examples include but are not limited to so-called smart phones, tablets, smart wearable devices (e.g., smart watches, fitness monitors that are worn on the body, etc.). In other cases, the network edge element may be configured to not be personally carried by a person, such as but not limited to smart refrigerators and pantries, entertainment and information platforms, exercise and sporting equipment, digital personal assistant (e.g., home and/or office digital assistances such as Amazon Alexa implemented on an Amazon Echo, Google Assistant implemented on a Google Home, etc.), and other such devices. This can occur when, for example, the network edge element is too large and/or too heavy to be reasonably carried by an ordinary average person, or not configured to easy transport. This can also occur when, for example, the network edge element has operating requirements ill-suited to the mobile environment that typifies the average person.

The inventory systems 104, in part, are configured to track sales of products from one or more shopping facilities and/or distribution of products from one or more distribution centers and/or fulfillment centers. This can include product identifiers of products sold, timing of product sales, pricing, location of sales, and other such information. The sales information is accessed by the forecasting system 102, via the distributed network 106, and evaluated to identify sales trends and/or patterns. In some embodiments, the forecasting system tracks the sales of one or more particular products relative to a particular expected change in season, such as based on previous year's historic sales, current rates of sales over one or more recent periods of time (e.g., last week, last couple of weeks, etc.). It has been determined that some products sell at greater quantities for some seasons than in others. For example, sunscreen may have greater quantities of sales during the summer season than during the fall season. The forecasting system 102 applies one or more rules that use the change in sales and/or changes in sales patterns of one or more products or sets of products in forecasting a change from one season to another, and/or confirming a change in season has occurred. The rules may identify threshold sales changes over one or more periods of time that are consistent with historic changes in sales during one or more similar period of time from one or more previous years, threshold changes in sales rates, and/or other such rules.

Some embodiments further evaluate historic weather data and historic sales data relative to the historic weather data and identify sales patterns and/or demand patterns of one or more products that correlate with changes of seasons and/or indicate a change in purchasing patterns of one or more products corresponding with changing seasons. Using the example above, the forecasting system may identify a threshold drop in sunscreen in one or more geographic regions as one indicator that product purchasing patterns are changing consistent with a change in season from summer to fall. One or more rules may define a threshold determined based historic changes in sunscreen relative to historic changes of season. Based on the detected changes in purchasing, the forecasting system can forecast and/or confirm a change from a first season to a second season (e.g., winter to spring). The forecasting system can further forecast expected changes in sales of at least some products and/or changes in sales patterns based on the forecasted change of season.

In some embodiments, the forecasting system may further evaluate the detected change in season to one or more historic changes in seasons. One or more rules may be applied to autonomously determine whether there is a threshold deviation in a timing of the change in season from an expected change in season, which may have been determined based on weather patterns relative to historic weather patterns, previous evaluations of changes in sales, and/or other such information. An alert may be generated in response to the detected deviation, which may trigger evaluation of changes of season in one or more other geographic areas.

Still further, by forecasting a change in season in a first geographic area that typically experiences the change in season prior to one or more other geographic areas, the forecasting system 102 can further forecast when in the future the season change is expected to occur in the one or more other geographic areas. Again, based on the changes in expected seasons, the forecasting system can forecast expected sales and/or changes in expected sales, and can initiate actions to adjust inventory and/or products ordered for stores in those geographic areas to correspond with expected changes in sales within those geographic areas.

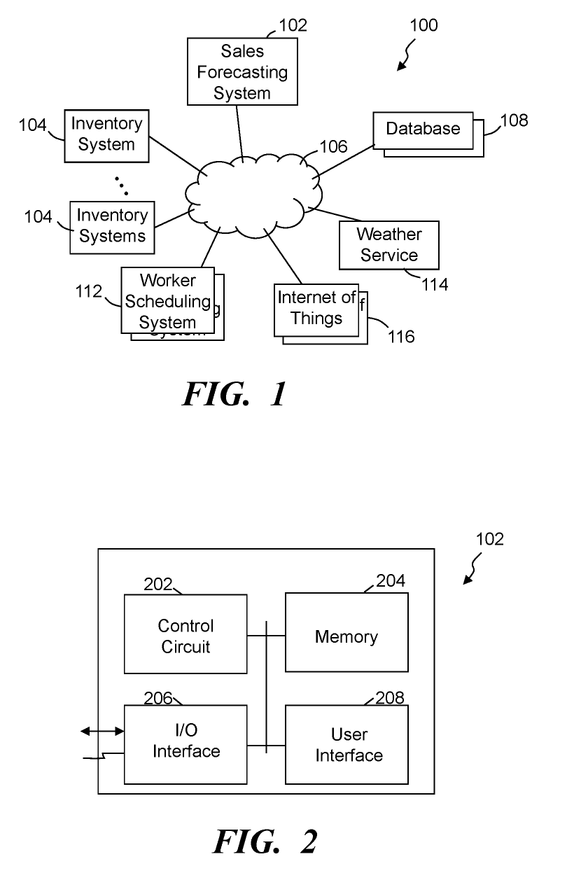

FIG. 2 illustrates a simplified block diagram of an exemplary sales forecasting system 102, in accordance with some embodiments. The sales forecasting system 102 includes one or more forecast control circuits 202, memory 204, and input/output (I/O) interfaces and/or devices 206. Some embodiments further include one or more user interfaces 208. The forecast control circuit 202 typically comprises one or more processors and/or microprocessors. The memory 204 stores the operational code or set of instructions that is executed by the forecast control circuit 202 and/or processor to implement the functionality of the sales forecasting system 102. In some embodiments, the memory 204 may also store some or all of particular data that may be used to evaluate historic weather data, evaluate historic sales data, track sales data, forecast changes in seasons, evaluate forecasted weather data, forecast changes in purchasing patterns, forecast product sales, and/or make other associations, determinations, measurements and/or communications described herein. Such data may be pre-stored in the memory 204, received from an external source, be determined, and/or communicated to the sales forecasting system.

It is understood that the forecast control circuit 202 and/or processor may be implemented as one or more processor devices as are well known in the art. Further, in some instances, the control circuit 202 may be implemented through multiple processors distributed over one or more computer networks. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Although the memory 204 is shown as internal to the sales forecasting system 102, the memory 204 can be internal, external or a combination of internal and external memory. While FIG. 2 illustrates the various components being coupled together via a bus, it is understood that the various components may actually be coupled to the control circuit 202 and/or one or more other components directly.

Further, the control circuit 202 and/or electronic components of the sales forecasting system 102 can comprise fixed-purpose hard-wired platforms or can comprise a partially or wholly programmable platform. These architectural options are well known and understood in the art and require no further description here. The sales forecasting system and/or control circuit 202 can be configured (for example, by using corresponding programming as will be well understood by those skilled in the art) to carry out one or more of the steps, actions, and/or functions described herein. In some implementations, the control circuit 202 and the memory 204 may be integrated together, such as in a microcontroller, application specification integrated circuit, field programmable gate array or other such device, or may be separate devices coupled together.

The I/O interface 206 allows wired and/or wireless communication coupling of the sales forecasting system 102 to external components, such as the inventory systems 104, databases 108, worker scheduling systems 112, weather services 114, marketing services and/or systems, distribution centers, and other such devices or systems. Typically, the I/O interface 206 provides wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The sales forecasting system may also include one or more user interfaces 208 that may be used for user input and/or output display. For example, the user interface 208 may include any known input devices, such one or more buttons, knobs, selectors, switches, keys, touch input surfaces, audio input, and/or displays, etc. Additionally, the user interface 208 include one or more output display devices, such as lights, visual indicators, display screens, etc. to convey information to a user/worker, such as but not limited to weather trends, sales trends, changes in sales patterns, sales data, inventory information, forecasted changes of a season, forecasted sales, forecasted changes in purchasing patterns, product orders, product information, shipping information, product location information, worker information, status information, communication information (e.g., text messages, emails, etc.), mapping information, operating status information, notifications, errors, conditions, and/or other such information. Similarly, the user interface 208 in some embodiments may include audio systems that can receive audio commands or requests verbally issued by a worker, and/or output audio content, alerts and the like.

In some embodiments, the forecasting system automates the forecasting of when a changing of a first season to a second season is to occur at a first geographic area that is expected to change seasons before one or more other geographic areas, and further automates the forecasting of a change of the season in the one or more other geographic areas based at least in part on historic differences in time of changes in season in the one or more other geographic areas relative to the first geographic area. The forecasting system may access product sales data, and evaluate the product data as at least part of the data used to forecast the future change in season and/or confirm a change in season. In some applications, the forecasting system forecasts and/or detects a changing from a first season to a second season based at least on a detected change in sales of at least a set of one or more products at a retail shopping facility located within the first geographic area. The change in sales can further be evaluated relative to calendar data regarding when a change in season is expected to occur.

As introduced above, the forecasting and/or detection of a change in a season can be based on historic actual sales data indicative of a change in seasons and/or seasonal purchasing patterns relative to historic weather conditions within the first geographic area. In some embodiments, the forecasting system in forecasting when a changing of a season is to occur at a first geographic area is configured to detect changes in sales that are consistent with historic changes in sales that correspond to historical changes of the season. Some embodiments further evaluate peoples' actions, intentions, and beliefs in implementing forecasting a change in season and corresponding changes in sales based on the expected change in season. Data may be received from numerous Internet of Things 116 that identify corresponding individual's actions, intentions and beliefs. The data may include calendar data, social media, Internet search parameters, on-line and retail store shopping and/or purchases, and other such data may be detected by one or more Internet of Things. Such data can be communicated to the sales forecasting system 102 and/or at least partially locally processed on the Internet of Things to identify a corresponding person's actions, intentions and/or beliefs relative to changes in season in their current geographic area. For example, the sales forecasting system may receive information that customers intend to continue to make purchases in late March consistent with winter purchases (e.g., customer is purchasing one or more snow shovels), indicating in some instances that the customers believe the winter is expected to continue for at least a limited duration. Based on this additional information, one or more rules may be applied in evaluating changes in a season forecasting at the relevant geographic area. For example, the rules may evaluate current and/or forecasted weather data relative to peoples' intentions and/or reactions to weather. The reactions by potential customers can be used to validate or confirm seasonal change forecasted by the sales forecasting system, and/or make adjustments to forecasted seasonal changes or at least adjustments relative to inventory orders and stocking to be consistent with forecasted sales.

Further, in some applications, the sales forecasting system accesses and/or receives customer intended action and/or intention data and/or action data from multiple different and distributed Internet of Things 116 each associated with at least a first geographic area or region. One or more rules can be applied to anticipate actions by a corresponding potential customer relative to expected sales and/or forecasting a change in season. Further, one or more rules can be applied to associate at least some of the intention action data with a geographic location corresponding to at least one and often multiple retail shopping facilities. The rules can, for example, identify a geographic region corresponding to intended customer actions relative to sales, and determine whether the intended actions are consistent with a forecasted change in season. Such rules may, for example, consider historic sales, historic weather data, customer's historic actions, whether anticipated actions are based on discounted pricing, incentives and/or advertising, other such information, and often a combination of such information. A forecasted change in season at a first geographic area and/or a second geographic area based on a seasonal delay may be adjusted based on the intention and/or actual action data. Further, the sales forecasting system in forecasting the expected sales can forecast product sales corresponding to modifications to a forecasted change in season based on the intended action data received from the Internet of Things 116 and corresponding to the geographic region. Some embodiments receive customer intention data from multiple different Internet of Things 116 associated with a first geographic area, apply one or more rules associate at least some of the customer intention data, and adjust a forecasted changing of a season based on the customer intention data. The adjustment may be proportional to, for example, the quantity of intended and/or actual continued purchases of products consistent with a current season, proportional to a number of customers similarly intending to and/or continuing to purchase products consistent with a current season, and the like. Similarly, the adjustment may include forecasting the change in season earlier than expected with customer intentions data corresponding to customers intending to purchase products consistent with an approaching season, with the adjustment being proportional to, for example, the quantity of intended purchases of products consistent with an approaching season, proportional to a number of customers similarly intending to purchase products consistent with an approaching season, and the like.

In some embodiments, the forecasting system continues to track sales data and confirms a change in seasons based on the sales data of one or more products and/or the changes in sales of one or more products. This confirmation can be used to further forecast future changes of the season from the first season to the second season at one or more other geographic areas that typically change from the first season to the second season a determined seasonal delay from the change in season at the first geographic location.

The forecasting system 102 further forecasts when in the future a changing of the first season to the second season at a different geographic area is to occur based at least in part on a seasonal delay factor of the second geographic area relative to the occurrence of the changing of the season at the first geographic area. In some embodiments, the seasonal delay factor is dependent on historical differences in time between when the changing of the season (e.g., from winter to spring) occurs at the first geographic area and the subsequent changing of the season (winter to fall) occurring at the second geographic area. Weather data can be accessed from the weather sources and/or database and evaluated relative to different geographic areas to identify delays in time in changes of seasons and/or weather patterns between a first geographic area and one or more other geographic areas. The delay may be determined based on an average delay, a mean delay, an average delay (excluding one or more unexpected delays (e.g., greater than two standard deviations from a mean)), and/or other such determined delay. In some embodiments, the forecasting of the change in season at a second geographic location may be determined based on seasonal delays between the second geographic location and two or more other geographic locations. For example, a change in season in a first geographic area that includes Denver, Colo. may take into consideration a seasonal delay between Denver and a second geographic area that includes Aspen, Colo., as well as seasonal delays between the first geographic area and a third geographic area that includes Cheyanne, Wyo., and a fifth geographic area that includes Minneapolis, Minn. In some instances, a weighting may be applied to the different seasonal delays. Still further, in some embodiments, the current weather trends at the first location and one or more second locations can be evaluated relative to historic trends to identify seasonal delays that are more likely to occur because of the current weather patterns.

stopped Based on the forecasted change in season at the first and/or second geographic areas, one or more inventory systems can adjust product orders and/or product distribution based on forecasted change of season at the second geographic area. In some embodiments an inventory system can adjust over time orders of one or more products or a set of products intended to be delivered to a retail shopping facility located in the second geographic area based on when the change from the season at the second geographic area is forecasted to occur. The inventory systems 104 can include a control circuit, memory, I/O interface, user interface, and the like (e.g., similar to those of the forecasting system 102). Information can be stored in the memory and/or accessed from the databases 108, and/or forecasting system 102, and used to adjust inventory, orders for products, and/or the distribution of products. An inventory system, for example, may store inventory information of one or more products at the shopping facility predicted to have sales affected by the change in seasons, whether the change is an increase or a decrease. Based on the forecasted demand and/or expected sales of one or more products, the inventory system can determine whether to order products or quantities of the one or more products to order for one or more shopping facilities within a given geographic area.

In some embodiments, the inventory system reduces overstocking of multiple products to be delivered to a retail shopping facility located in a geographic area based on the forecasted change from the first season at that geographic area. In part, the inventory can reduce or prevent further orders for one or more products based on on-hand quantities at the shopping facility and the forecasted sales and/or a forecasted change in a sales pattern. Further, in some embodiments, the forecasting system 102 and/or inventory system 104 can modify a sales strategy of one or more product corresponding to the forecasted sales at a retail shopping facility based on the forecasted change from the first season to the second season at the geographic area and the inventory information corresponding to at least the one or more products. In some embodiments, inventory information is maintained of an inventory of products for sale at a second retail shopping facility located in the second geographic area. A sales strategy of at least a first product of the first set of products can be modified at the second retail shopping facility based on the forecasted change from the first season at the second geographic area and the inventory information corresponding to at least the first product.

In some instances, for example, the forecasting system 102 and/or the inventory system 104 may cause one or more products to be reduced in price, moved to a more prominent location within a shopping facility, advertised or emphasized in advertisements, communications sent to one or more customers highlighting one or more products (e.g., ground mail, text message, through an APP, etc.), and/or other such modifications to sales strategies. Similarly, marketing strategies may be developed for one or more and/or a set of products based on predicted changes in sales (e.g., reductions, increases, etc.) as a result of forecasted changes of seasons. The marketing strategy may, for example, initially increase exposure of the one or more products of a first future period of time, schedule the prices to be reduced on the one or more products over a subsequent second future period of time, then place the remaining items of the one or more products on clearance (e.g., further reduced pricing with placement in a clearance area) during a subsequent third future period of time based on a forecasted and/or confirmed change in a season.

It has further been identified that, in some instances, when some detected decreases in sales occur at a shopping facility, an assumption may be made that the shopping facility is low or out of that product. Based on this determination additional items of that product may be ordered for the shopping facility and pushed to that shopping facility in attempts to increase the on-hand inventory of that product and increase sales. However, in some instances, the decrease in sales is not a result of a lack of inventory or lack of stocking, but instead is a result of changing purchasing patterns due to changes in seasons and/or weather patterns. Accordingly, some embodiments attempt to limit or avoid over stocking one or more products by recognizes that the change in sales corresponds to a change of the season. In some embodiments, the inventory system 104 confirms that an aberration in sales, at a retail shopping facility located in a second geographic area, of one or more products is consistent with the forecasted changing from the season at the second geographic area.

Some embodiments further consider current weather conditions and/or forecasted weather conditions in predicting when a seasonal change is expected. The forecasted weather conditions can include forecasted temperatures, precipitation, and the like. The forecast control circuit, in some instances, is further configured to modify the forecast of when the changing from a first season to a second season is to occur at a second geographic area as a function of forecasted temperature changes. Further, in some applications, the forecasting system can evaluate the forecasted weather data relative to historic weather data in attempting to identify historic changes in a season associated with similar weather to that forecasted. Some embodiments additionally consider historic changes in sales corresponding to these historic periods of time to identify changes in a season and/or forecasting demand, expected sales and/or changes in purchasing patterns.

As described above, the forecasted and/or determined change in a season in a first geographic area is used to forecast a change in the season in one or more other geographic areas based on seasonal delays between the first geographic location and the one or more other geographic areas. With many geographic areas, the seasonal delays may generally correspond with differences in latitude (e.g., the further north a geographic area is generally the later it is expected to change from winter to spring and spring to summer; and the further south a geographic area is generally the later it is expected to change from summer to fall and from fall to winter). Some embodiments additional or alternatively take into consideration geographic areas with differing altitudes in determine seasonal delays between geographic areas and forecasting changes in seasons and/or changes in product demands as a result of changes in seasons and/or weather. Accordingly, in some implementations, the forecasting system forecasts and/or determines a change in season at a first geographic area that is at a first altitude, and forecasts when in the future a change in the season is expected at a second geographic area that is at a second different altitude than the first geographic location.

Some embodiments further create clusters of shopping facilities, distribution centers, fulfillment centers, and the like, based on their location within an area that is forecasted or expected to change from one season to another at about the same time or within a threshold period of time (e.g., within one day, within three days, etc., where the threshold may vary based on one or more factors, such as time to receive a delivery, on-hand inventory, and/or other such factors). Similarly, some embodiments may cluster multiple shopping facilities, distribution centers, fulfillment centers, and the like, that are in different geographic areas or locations, but that are forecasted or expected to change from one season to another at about the same time or within a threshold period of time. The forecasting system can define a cluster of multiple retail shopping facilities that are in one or more geographic areas forecasted to change seasons within a threshold period of time, and forecast expected changes in a season and/or expected sales of one or more products as a function of one or more forecasted of detected changes of season at one or more other geographic areas and associated seasonal delays. The clustering or the exclusion from a cluster may further take into consideration current and/or forecasted weather at the different geographic locations. In some applications, the identification of different geographic areas that may be clustered can include an evaluation of historic weather data and/or sales data, and the clustering can consider geographic areas that historically change from a first season to a second season within a threshold period of time of each other such that they are considered to change seasons at substantially the same time. It is noted that different clusterings of geographic areas may be specified for different seasons and/or for different years. For example, a first store may be in associated with a first cluster for a change from spring to summer, but be associated with a second cluster for a change from fall to winter.

As described above, some embodiments further consider data in evaluating seasonal changes that includes intended actions and/or actual actions based on information and/or activity monitoring, which can be based, in whole or in part, upon sensor inputs from the Internet of Things 116. Again, the Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure (e.g., network 108). Some experts estimate that the Internet of Things will consist of almost 50 billion such objects by 2020. Depending upon what sensors a person encounters, information can be available regarding a person's travels, lifestyle, calorie expenditure over time, diet, habits, interests and affinities, choices and assumed risks, and so forth.

Some embodiments accommodate either or both real-time or non-real time access to such information as well as either or both push and pull-based paradigms. By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives). Expected future changes and/or actual changes to that established routine can further be anticipated based on obtained information (e.g., reservation information, purchases, Internet search queries, etc.) and/or detected. These teachings are highly flexible in these regards and will accommodate a wide variety of “changes.” Some illustrative examples include but are not limited to predicted purchases, changes in scheduled events, the purchase and/or use of new and/or different products or services, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon forecasting and/or detecting a change some embodiments accommodate assessing whether the detected change constitutes a sufficient amount of data to warrant proceeding further with utilizing such data in forecasting a change of season and/or purchases at a corresponding one or more shopping facilities at one or more geographic locations. This assessment can comprise, for example, assessing whether a sufficient number (i.e., a predetermined number) of instances of data corresponding to this particular detected or forecasted change have occurred over some predetermined period of time. As another example, this assessment can comprise assessing whether the specific details of the detected or forecasted change are sufficient in quantity and/or quality to warrant further processing. For example, merely detecting that the person has searched for one or more products corresponding to a particular season may not be enough information, in and of itself, to warrant further processing, in which case the information regarding the forecasted or detected change may be discarded or, in the alternative, cached for further consideration and use in conjunction or aggregation with other, later-detected data and/or changes. The data, when relevant, can be utilized in forecasting future sales and corresponding continuation or change in season relative to a geographic area.

It will be appreciated that the forecasting system 100 can be viewed as a literal physical architecture or, if desired, as a logical construct. For example, these teachings can be enabled and operated in a highly centralized manner (as might be suggested when viewing the system as a physical construct) or, conversely, can be enabled and operated in a highly decentralized manner. In an illustrative example, the sales forecasting system 102 may be implemented through one or more central cloud servers, which communicate with the inventory system 104, worker scheduling system 112, databases 108, weather service(s) 114, and the aforementioned Internet of Things 116 via the network 106. Further, in some applications, some or all of the sales forecasting system 102 may be implemented though a distribution of process. For example, some of the rules may be implemented local on one or more of the Internet of Things 116, with resulting data provided to a more central sales forecasting system.

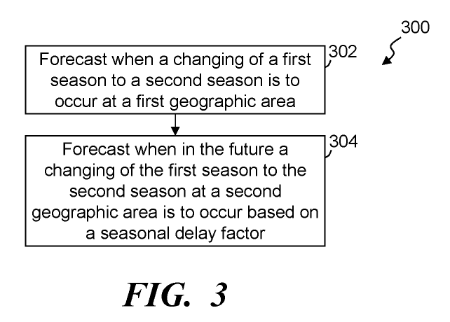

FIG. 3 illustrates a simplified flow diagram of an exemplary process 300 of forecast seasonal transitions in retail sales, in accordance with some embodiments. In step 302, it is forecasted when a changing of a first season to a second season is to occur at a first geographic area based at least in part on a detected change in sales of at least a first set of products at a first retail shopping facility located within the first geographic area. Some embodiments may additionally or alternatively identify that a change of seasons is occurring or has recently occurred at the first geographic area based on a detected change in sales of at least a first set of products at a first retail shopping facility located within the first geographic area.

In step 304, it is forecasted when in the future a second changing of the first season to the second season at a second geographic area, and typically within the same year, is to occur based on a seasonal delay factor of the second geographic area relative to the occurrence of the changing of the first season at the first geographic area. In some embodiments, the seasonal delay factor is dependent on historical differences in time between when the changing from the first season occurs at the first geographic area and the subsequent changing from the first season occurring at the second geographic area. Further, some embodiments in forecasting when the first changing of the first season is to occur at the first geographic area detect changes in sales that are consistent with historic changes in sales that correspond to historical changes of the first season. The forecasted change in season at a first geographic area may in some applications be additionally based on weather conditions within the first geographic area indicative of a change in seasons relative to historic actual sales data historic.

In some embodiments, the forecasting system continues to evaluate sales data at a first shopping facility and weather data in a first geographic area where the first shopping facility is located after having predicted a change of season. Based on the evaluation, the forecasting system can confirm a change of season and/or a time over which the change of season occurred. The confirmation can be used in subsequent forecasting of other geographic areas based on the seasonal delays between a change of season at the first geographic area relative to one or more other geographic areas. In some implementations, the forecasting system can continue to evaluate sales data and weather data at the one or more other geographic areas to forecast changes in season at the one or more other areas and use the forecasted changes in combination with one or more seasonal delays relative to one or more geographic areas in forecasting a change of season and/or changes in purchasing patterns at the one or more other areas. Similarly, some embodiments further consider current weather patterns in addition to seasonal delays and forecasting based on changes in sales patterns of one or more products. For example, if current and forecasted weather indicates continued colder weather than typical, the forecasting system can adjust forecasting of a change of season from winter to spring, particularly when the colder weather is accompanied by snow fall. Some embodiments apply weightings to forecasting based on seasonal delays, current weather and/or the forecasting based on changes in sales of products.

Some embodiments adjust over time orders of multiple products of at least the first set of products intended to be delivered to a second retail shopping facility located in the second geographic area based on the forecasted change from the first season at the second geographic area. In some applications, overstocking of multiple products to be delivered to a second retail shopping facility located in the second geographic area is reduced based on the forecasted change from the first season at the second geographic area. This can include reducing orders for one or more products, adjusting sales strategies of the one or more products and the like.

In some embodiments, the forecasting system 102 is further in communication with one or more worker scheduling circuits 112. The worker scheduling circuit can be configured to adjust worker schedules corresponding to forecasted changes from a season determined by the forecasting system based at least in part on the detected changes in sales and/or one or more seasonal delays corresponding to one or more other geographic areas. Based on the forecasted change in season, the worker scheduling circuit can adjust numbers of workers scheduled during at least a portion of one or more future periods of time based on forecasted sales, changing of products, reorganization of the shopping facility, and other such tasks based on changing seasons. This can correspond to forecasted increases or decreases of sales of products at one or more shopping facilities. For example, in response to expected tasks to be performed at a particular shopping facility, the worker scheduling circuit can schedule additional workers to stock products, provide additional customer service, set up displays, operate point-of-sale (POS) systems, and/or other such tasks. The forecasting of changes from one season to another enables the forecasting system to increase or decrease inventory of one or more products in advance to correspond to with forecasted changes in demands of those products.

In some embodiments, an aberration in sales at the second retail shopping facility, located in the second geographic area, of one or more products is confirmed to be consistent with expected changes in sales based on the predicted second changing from the first season. Further, some embodiments consider current and/or forecasted weather data in forecasting changes in seasons. The forecast of when the second changing from the first season is to occur at the second geographic area may be modified as a function of forecasted temperature changes. Further, the different geographic locations may be different based in part on altitude. For example, the second geographic area may be at a different altitude than the first geographic area, and the difference in altitudes results in a separation in time of when there is a change from a first season to a second season.

Some embodiments provide systems, apparatuses, method and processes of forecasting changes in seasons and/or changes in expected sales at one or more retail shopping facilities. In some embodiments, a system includes a forecast control circuit; a memory coupled to the forecast control circuit and storing computer instructions that when executed by the forecast control circuit cause the forecast control circuit to: forecast when a first changing of a first season to a second season is to occur at a first geographic area based on a detected change in sales of at least a first set of products at a first retail shopping facility located within the first geographic area; and forecast when in the future a second changing of the first season to the second season at a second geographic area is to occur based on a seasonal delay factor of the second geographic area relative to the occurrence of the changing of the first season at the first geographic area.

Some embodiments, provide methods of forecast seasonal transitions in retail sales, comprising: by a forecast control circuit: forecasting when a first changing of a first season to a second season is to occur at a first geographic area based on a detected change in sales of at least a first set of products at a first retail shopping facility located within the first geographic area; and forecasting when in the future a second changing of the first season to the second season at a second geographic area is to occur based on a seasonal delay factor of the second geographic area relative to the occurrence of the changing of the first season at the first geographic area.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to forecast seasonal transitions in retail sales, comprising:
a forecast control circuit;
a memory coupled to the forecast control circuit and storing computer instructions that when executed by the forecast control circuit cause the forecast control circuit to:
forecast when a first changing of a first season to a second season is to occur at a first geographic area based on a detected change in sales of at least a first set of products at a first retail shopping facility located within the first geographic area; and
forecast when in the future a second changing of the first season to the second season at a second geographic area is to occur based on a seasonal delay factor of the second geographic area relative to the occurrence of the changing of the first season at the first geographic area.

2. The system of claim 1, wherein the seasonal delay factor is dependent on historical differences in time between when the changing from the first season occurs at the first geographic area and the subsequent changing from the first season occurring at the second geographic area.

3. The system of claim 1, further comprising:
an inventory system configured to adjust over time orders of multiple products of at least the first set of products intended to be delivered to a second retail shopping facility located in the second geographic area based on the forecasted change from the first season at the second geographic area.

4. The system of claim 1, further comprising:
an inventory system configured to reduce overstocking of multiple products to be delivered to a second retail shopping facility located in the second geographic area based on the forecasted change from the first season at the second geographic area.

5. The system of claim 1, further comprising:
an inventory system comprising memory storing inventory information of an inventory of products for sale at a second retail shopping facility located in the second geographic area, wherein the inventory system is configured to modify a sales strategy of at least a first product of the first set of products at the second retail shopping facility based on the forecasted change from the first season at the second geographic area and the inventory information corresponding to at least the first product.

6. The system of claim 1, wherein the forecast control circuit, in forecasting when the first changing of the first season is to occur at the first geographic area, is configured to detect changes in sales that are consistent with historic changes in sales that correspond to historical changes of the first season.

7. The system of claim 1, further comprising:
an inventory system configured to confirm that an aberration in sales at a second retail shopping facility located in the second geographic area of one or more products is consistent with expected changes in sales based on the forecasted second changing from the first season.

8. The system of claim 1, wherein the forecast control circuit is further configured to modify the forecast of when the second changing from the first season is to occur at the second geographic area as a function of forecasted temperature changes.

9. The system of claim 1, wherein the second geographic area is at a different altitude than the first geographic area.

10. The system of claim 1, wherein the forecast control circuit is further configured to receive customer intention data from multiple different Internet of Things associated with the first geographic area, and apply one or more rules associate at least some of the customer intention data;
wherein the forecast control circuit in forecasting the first changing of the first season is configured to adjust the forecasted first changing based on the customer intention data.

11. A method of forecast seasonal transitions in retail sales, comprising:
by a forecast control circuit:
forecasting when a first changing of a first season to a second season is to occur at a first geographic area based on a detected change in sales of at least a first set of products at a first retail shopping facility located within the first geographic area; and
forecasting when in the future a second changing of the first season to the second season at a second geographic area is to occur based on a seasonal delay factor of the second geographic area relative to the occurrence of the changing of the first season at the first geographic area.

12. The method of claim 11, wherein the seasonal delay factor is dependent on historical differences in time between when the changing from the first season occurs at the first geographic area and the subsequent changing from the first season occurring at the second geographic area.

13. The method of claim 11, further comprising:
adjusting over time orders of multiple products of at least the first set of products intended to be delivered to a second retail shopping facility located in the second geographic area based on the forecasted change from the first season at the second geographic area.

14. The method of claim 11, further comprising:
reducing overstocking of multiple products to be delivered to a second retail shopping facility located in the second geographic area based on the forecasted change from the first season at the second geographic area.

15. The method of claim 11, further comprising:
maintaining inventory information of an inventory of products for sale at a second retail shopping facility located in the second geographic area; and
modifying a sales strategy of at least a first product of the first set of products at the second retail shopping facility based on the forecasted change from the first season at the second geographic area and the inventory information corresponding to at least the first product.

16. The method of claim 11, wherein the forecasting when the first changing of the first season is to occur at the first geographic area comprises detecting changes in sales that are consistent with historic changes in sales that correspond to historical changes of the first season.

17. The method of claim 11, further comprising:
confirming that an aberration in sales at the second retail shopping facility located in the second geographic area of one or more products is consistent with expected changes in sales based on the predicted second changing from the first season.

18. The method of claim 11, further comprising:
modifying the forecast of when the second changing from the first season is to occur at the second geographic area as a function of forecasted temperature changes.

19. The method of claim 11, wherein the second geographic area is at a different altitude than the first geographic area.
